(19) United States
(12) Patent Application Publication
(10) Pub. No.: US 2001/0032109 A1
(43) Pub. Date: Oct. 18, 2001

(54) System and method for predicting a maintenance schedule and costs for performing future service events of a product

(76) Inventors: Richard Jeremiah Gonyea, Scotia, NY (US); Christopher Reynolds Hammond, Schenectady, NY (US); Mary Clarkeson Phillips, Delmar, NY (US); Vrinda Rajiv, Guilderland, NY (US); Donald Scott Warren, Woodstock, GA (US); Abani Pattanayak, Orissa (IN); Kannan Arumugam, Marietta, GA (US); Frank Garfield Avery JR., Alpharetta, GA (US); Srinivas Bollapragada, Schenectady, NY (US); Marc Anthony Garbiras, Albany, NY (US); Kevin Bernard Kenny, Niskayuna, NY (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(21) Appl. No.: 09/728,225

(22) Filed: Nov. 30, 2000

Related U.S. Application Data
(60) Provisional application No. 60/196,815, filed on Apr. 13, 2000.

(51) Int. Cl. G06F 17/60

(52) U.S. Cl. 705/8

(57) ABSTRACT

A system and method for predicting the timing and costs of future service events. A scheduler determines a list of future service events for the product. A simulator simulates each of the listed future service events for the product and predicts the costs associated with the events. The list of the future service events and the total of the predicted costs are aggregated into a prediction that may be used in offering long term service agreements to maintain the product.

### CROSS-REFERENCE TO RELATED APPLICATIONS

This application claims the benefit of U.S. Provisional Application No. 60/196,815, filed Apr. 13, 2000.

### BACKGROUND OF THE INVENTION

This disclosure relates generally to servicing products and systems and more particularly to predicting a maintenance schedule and costs for performing future service events of a product or a system.

Over the past several years there has been tremendous growth in the services business. Many manufacturers and service organizations are now offering long term service agreements to maintain and service repairable products and systems such as power generation equipment, aircraft engines, automobiles, locomotives and other high tech products. Typically, these long term service agreements have a multi-year duration that can range from 10-20 years. In addition, the long term service agreements have an associated liability in the millions. In order for the manufacturers and the service organizations to assume the risk associated with the long term service agreements, they must have an accurate prediction of all maintenance and service associated with the products or systems and their costs.

Therefore, there is a need for an approach that can predict a maintenance schedule of future service events for a product or system and the costs associated with these events for the duration of a long term service agreement.

### BRIEF SUMMARY OF THE INVENTION

The system and method of the present invention predict a maintenance schedule and costs for performing future service events on a product formed from a plurality of components. The maintenance schedule and costs of the future service events are used to predict the cost and price of a long term service agreement for the product. A scheduler predicts the maintenance schedule based on the operating conditions the product is exposed to, as well as on design limits or constraints for the components of the system. The design limits or constraints are defined in terms of operating hours, based on the operating conditions, to which the sub-components of each component are exposed. The design constraints are also defined in terms of business rules and design curves for each component and sub-component. The scheduler determines the operating time for each sub-component based on the operating conditions for a predetermined time period and compares it to the design limit for the component. Once a design limit is exceeded for a sub-component, the scheduler then schedules a maintenance event to repair or replace the component and its related sub-components. A simulator takes the predicted maintenance schedule and simulates the maintenance events to determine the cost of the maintenance events. A aggregator then aggregates the predicted maintenance schedule and the predicted costs for the length of the service agreement to obtain a complete schedule of future maintenance events and a total cost representative of fulfilling the service agreement for the product.

### BRIEF DESCRIPTION OF THE DRAWINGS

FIG. 1 is a schematic representation of a general purpose computer system in which a system for predicting a maintenance schedule and costs for performing future service events of a product operates;

FIG. 2 is a schematic representation of the architecture of the system for predicting a maintenance schedule and costs for performing future service events of a product;

FIG. 3 is a flowchart describing actions performed by the system for predicting a maintenance schedule and costs for performing future service events of a product;

FIG. 4 is a flowchart describing actions performed by another embodiment of a system for predicting a maintenance schedule and costs for performing future service events of a product;

FIG. 5 is a flowchart describing actions performed in one embodiment of calculating a maintenance schedule for a product;

FIG. 6 is a flowchart describing actions performed in one embodiment of calculating maintenance costs for a product; and

FIG. 7 is a flowchart describing actions performed in one embodiment of simulating the service costs and risks in predicting the maintenance costs for a product.

### DETAILED DESCRIPTION OF THE INVENTION

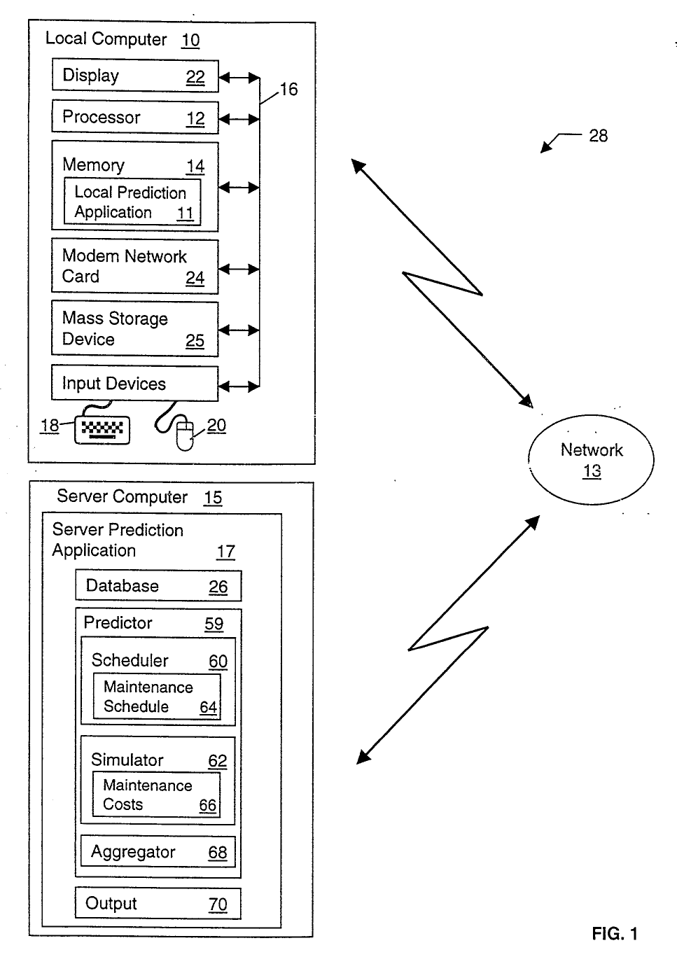

Referring to FIG. 1, a system 28 for predicting a maintenance schedule and costs for performing future service events on a product includes a local computer 10 running a local prediction application 11 in communication through a network 13 with a server computer 15 running a server prediction application 17. The arrangement of the local computer 10 and the server computer 15 forms a client-server system, splitting tasks to be performed by the prediction system 28 between the two computers. A user of the local computer 10 inputs data for a product, such as operating conditions for a given time period, and the data is sent through the network 13 to the server computer 15. Through the prediction application 17, the server computer 15 accesses data within a database 26 that is associated with the incoming data in order to operate an aggregator 59 including a scheduler 60, a simulator 62 and an aggregator 68 to determine an output 70. The output 70 includes an aggregated maintenance schedule and costs, which is returned to the local computer 10 for display, review and manipulation.

The local computer 10 is one of a plurality of a general-purpose computer systems on the network 13 in which the system 28 for predicting a maintenance schedule and costs for performing future service events of a product operates. The local computer 10 generally includes a processor 12, a memory 14, input/output devices, and data pathways (e.g., buses) 16 connecting the processor, memory and input/output devices. The processor 12 accepts instructions and data from the memory 14 and performs various calculations. The processor 12 includes an arithmetic logic unit (ALU) that performs arithmetic and logical operations and a control unit that extracts instructions from memory 14 and decodes and executes them, calling on the ALU when necessary. The memory 14 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices.

The input/output devices include a keyboard 18 and a mouse 20 that enter data and instructions into the local computer 10. A display 22 allows a user to see what the computer has accomplished. Other output devices could include a printer, plotter, synthesizer and speakers. A modem or network card 24 enables the local computer 10 to access other computers and resources on the network 13. A mass storage device 25 allows the local computer 10 to permanently retain large amounts of data. The mass storage device 25 may include all types of disk drives such as floppy disks, hard disks and optical disks, as well as tape drives that can read and write data onto a tape that could include digital audio tapes (DAT), digital linear tapes (DLT), or other magnetically coded media. The above-described local computer 10 can take the form of a hand-held digital computer, personal digital assistant computer, personal computer, workstation, mini-computer, mainframe computer and supercomputer.

The server computer 15 may include all of the same components described above for the local computer 10. The server computer 15 is preferably configured to store and process large amounts of data, however, thereby increasing the speed of the local computer 10. A suitable example of a server computer 15 includes a Sun Solaris Server Computer, as well as other servers manufactured by to run Unix or Windows-type server systems.

The network 13 is a system that enables communications, including the exchange of data, among a plurality of computers. The network 13 may be a private communications network or a public communications network. For example, the network 13 may be a local area network (LAN), a wide area network (WAN), the Internet, or other similar networks.

As described above, the system and network include a “thin client system” or Web system, in other words where the majority of the data storage and processing capabilities are within the server computer 15. Alternatively, the system may be configured as a “thick client system” where the server computer 15 primarily includes the data storage capabilities while the local computer handles the majority of the processing involved with prediction of the aggregated schedule and costs.

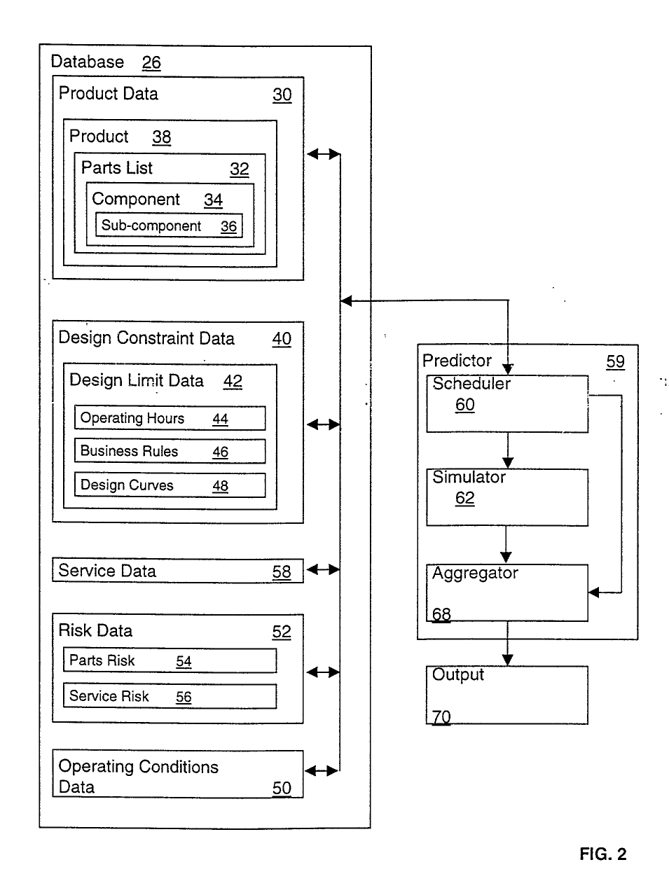

Referring to FIG. 2, the server computer 15 includes the database 26 for the storage and retrieval of large amounts of data relating to predicting maintenance schedules and costs. The data within database 26 includes files having lists and tables, among other forms of data. For example, product data 30 includes data relating to parts list 32 that detail the components 34 and sub-components 36 that make up each unit or product 38 for which a service contract may be desired. The components 34 and sub-components 36 are assemblies, sub-assemblies and piece-parts that make up a finished product 38.

The product data 30 is associated with design constraint data 40 that includes design limit data 42 for each item in the parts list 32 for each product 38. The design limit 42 for each part assembled into product 38 is defined in terms of operating time 44, for example in operating hours. The operating hours 44 may further be defined for a new part and for a refurbished part. Further, the design limit data 42 may include information on how many times a part may be refurbished or repaired before it is no longer considered useable. The design limit data may also include information on a parts' exposure to other predefined operating variables that may be particularly important in determining the life of the part. For examples, in power generation equipment, the number of starts a part is exposed to needs to be considered. Preferably, the design limit operating hours 44 are defined in a normalized unit of measure, thereby allowing the wear and tear associated with various operating conditions to be converted into one standard operating hour measure that is used to define the design limit of the part. To aid in determining the operating hours 44 in the normalized measure, the design constraint data 40 additionally may include business rules 46 and design curves 48 for each part. The business rules 46 include suggested maintenance guidelines for the relevant product 38. The design curves 48 include graphical representations of the performance of a part, in terms of operating hours, for a given set of operating conditions.

The operating conditions data 50 is used in conjunction with the design limit data 42 in predicting maintenance schedules and costs. The operating conditions data 50 includes a given set of operating conditions, applied for a given time period within the term of the service contract, that affect the maintenance requirements of a product 38 for which a service contract may be desired. The relevant set of operating conditions will vary, quantitatively and qualitatively, depending on the product 38 and the scenario within which the product is being used. For example, the amount of time within the given time period that the product 38 is actually in use and the details of the operating environment typically are relevant operating condition variables. Typically, the information within the operating conditions data 50 is supplied by the owner of the product 38, but nominal or forecasted values may be utilized for estimation purposes.

Additionally, risk data 52 is associated with the product data 30, the design constraint data 40 and the operating conditions data 50. The risk data 52 includes a parts risk variable 54 and a service risk variable 56, respectively, that are associated with each item in the parts list 32 and each task within a service event, discussed in more detail below, in determining the predicted maintenance schedule and cost for each product 38. The parts risk 54 and service risk 56 may be used to account for potential variability in parts cost, service cost and parts and service reliability. The parts risk 54 and service risk 56, for example, may be variables that are functions of the part cost and service cost, respectively. For example, for a part or service having a relatively high variability in cost and/or reliability, the risk variables 54 and 56 may be multiplied by the parts cost and service cost, respectively, to result in a higher number in order to account for the relatively higher risk associated with the part or service. In general, the parts risk 54 and service risk 56 increase with the complexity of a part or service, i.e. the number and complexity of assemblies within a part and the number of procedures and parts involved in a service.

Further, service data 58 includes details on the required tasks and parts involved in any maintenance event that may be predicted by the system 28. The service data 58 also includes the service costs associated with performing the tasks of the maintenance event.

The information from data files 30, 40, 50, 52 and 58 is utilized by a scheduler 60 and a simulator 62 to determine a maintenance schedule 64 and the associated maintenance costs 66 for each task in a maintenance event, preferably for the term of a service contract to estimate the cost of the contract. In particular, for each part in the parts list 32 for a given product 38, the scheduler 60 processes the set of given operating conditions from the operating conditions data 50 with the design limit data 42 from the design constraint data 40 to determine the maintenance schedule 64. The scheduler 60 sends the maintenance schedule 64 to both the simulator 62 and the aggregator 68. The simulator 62 utilizes the maintenance schedule 64 in combination with information from the product data 30 and service data 58 to determine and output the maintenance costs 66. The maintenance schedule 64 and associated costs 66 are then compiled and aggregated by a aggregator 68 to produce an output 70, which is the predicted aggregated maintenance schedule and costs for performing future service events on a product over the term of a service contract.

The scheduler 60, simulator 62 and aggregator 68 are typically software applications, and may be a single application. Although typically software-based, these components may include software, hardware, firmware or combinations thereof. Further, although described separately, data files 30, 40, 50, 52 and 58 may be a single data file or they may be contained in separate databases.

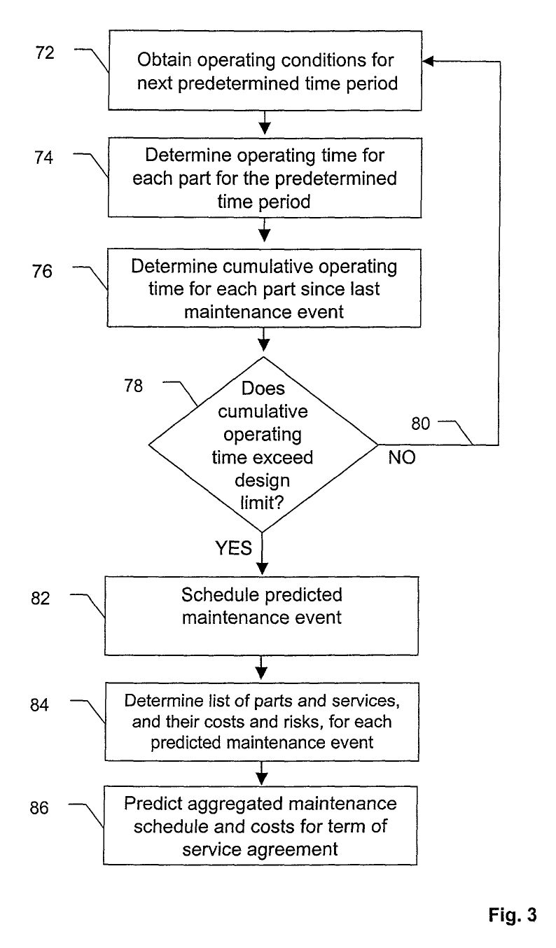

In operation, referring to FIG. 3, a method of predicting a maintenance schedule and costs of future service events of a product to be serviced under a long term service agreement includes obtaining the operating conditions for the product for a predetermined time period (Step 72). The operating conditions preferably are obtained from the owner of the product and input into the operating conditions data 50 (FIG. 2). However, the operating conditions may be input into the system 28 from other sources or the operating conditions may be estimated. Preferably, the predetermined time period corresponds to the time period of the long term service agreement. Additionally, the operating conditions may include a plurality of sets of operating conditions, where each set is associated with a portion of the predetermined time period. For example, the operating conditions may change on a monthly basis, and therefore to analyze the maintenance schedule and cost for a year, 12 different sets of operating conditions would be obtained corresponding to each month of the year.

Once the operating conditions are obtained for the product, the system 28 (FIG. 2) determines the operating time for each part of the product for the predetermined time period under the given operating conditions (Step 74). As mentioned above, the operating time relates to a normalized measure of the wear and tear on, or reduced useful life of, the part based on the operating conditions. Further, the operating time is determined using the design constraint data 40 (FIG. 2) and risk data 52 (FIG. 2). Then, the system 28 determines the cumulative operating time of each part of the product since the last maintenance event (Step 76). This involves adding the operating time for the predetermined time period to the operating time of each part that existed at the start of the predetermined time period. All of this data is maintained in the database 26. Once the cumulative operating time for each part is determined, then the cumulative operating time is compared to a predetermined design limit for each part (Step 78). The system 28 retrieves the design limit data 42 (FIG. 2) for each part to determine whether the cumulative operating time for the part is greater than the predetermined design limit in order to predict a maintenance schedule. If the cumulative operating time does not exceed the predetermined design limit, then the system 28 may return to Step 72 to begin the analysis for another predetermined time period and set of operating conditions until the end of the long term service agreement is reached (Step 80). If the cumulative operating time exceeds the predetermined design limit, then the system 28 schedules a predicted maintenance event to replace the part (Step 82). In scheduling the maintenance event, the system 28 is able to calculate the exact time within the predetermined time period that the part exceeds the predetermined design limit, and the system schedules the maintenance event to occur within the predetermined time period prior to this exact time. Thus, the maintenance event is scheduled prior to exceeding the design limit, thereby avoiding a potential failure of the part and a potential failure of the product.

Once the system 28, through the scheduler 60 (FIG. 2), predicts the maintenance schedule over the term of the service agreement, then the system utilizes the simulator 62 to predict the cost associated with the maintenance services. For each predicted maintenance event that is scheduled for the product, the system 28 generates a list of parts and a list of services, and their associated cost and risk (Step 84). The simulator 62 utilizes the service data 58, the risk data 52 and the product data 30 in order to analyze each part that needs maintenance, the associated parts that are affected, the related services involved in the maintenance event, and the costs and risks involved for each part and service task. Through the aggregator 68 (FIG. 2), the system 28 accumulates the predicted maintenance schedule 64 and the predicted service costs 66 and generates an aggregated maintenance schedule and costs, or output 70 (FIG. 2), for the product for the term of the service agreement (Step 86). The output 70 includes the total costs involved in the long term service agreement, as well as breaking down the costs and risks down to the individual part or service task level associated with each particular maintenance event.

In this disclosure, the system 28 for predicting a maintenance schedule and costs for performing future service events of a product will be further described with reference to power generation equipment such as a gas turbine or a steam turbine. However, other systems such as an aircraft engine, a locomotive or any other electrical, chemical or mechanical systems, where it is desirable to predict a maintenance schedule and costs for performing future service events of a product, may be used with the teachings of this disclosure. In the power generation equipment scenario, the maintenance requirements for the gas and steam turbine units depend on several operational factors, such as: (1) unit model; (2) design features of parts in the unit; (3) environment that unit is operating in; (4) type of fuel used; (5) number of hours of operation; (6) number of times the unit is started in a month; (7) number of trips, where a trip is a sudden and unexpected stoppage of the unit, where a variable may be utilized to equate one trip to a predetermined number of starts or a portion of a start; (8) reliability needs; (9) utilization needs; and (10) reserve requirements. Although this disclosure is described with reference to these operational factors, one of ordinary skill in the art will recognize that other factors could be used with the teachings of this disclosure.

The method for predicting the maintenance schedule and costs of future service events of power generation equipment takes these operational factors into account in determining a schedule setting forth the timing of the service events for the units and costs associated with performing these events. After obtaining the schedule of the service events and the costs associated therewith, one can predict the costs and price of a long term service agreement for one of these power generation units. A more detailed explanation of determining the schedule and predicting the costs of performing the scheduled events is set forth below.

### Determining Schedule

This determination comprises coming up with a detailed list of all service events for a power generation unit that are expected to occur in the future on a long term service agreement contract along with their dates. Similar determinations may be made for many other types of equipment, such as aircraft engines for example. Based on the contract information, which includes the customer sites, the units to be maintained, their operating conditions etc., the future inspections that have to be performed on each unit in the contract are generated as follows.

1. Calculate the factored fired hours (FFH) and factored fired starts (FFS) based on the operating conditions and the unit model;

2. At the end of each time period, check to see if any design limits on a part have been exceeded; and

3. If so, schedule an appropriate maintenance inspection.

In this case, the factored fired hours and factored fired starts are normalized measures of the operating life of the parts of the power generation equipment based on the operating conditions. The factored fired hours correspond to normal operating conditions and are associated with a factored fired hours design limit. The factored fired starts correspond to the operating conditions when the unit is first started, since the start-up conditions affect the life of the part. The predicted inspections on all the units are sequenced by the time of their occurrence. Any other events that are necessary for purchasing spare parts, etc. are also included in the schedule. The schedule is adjusted to ensure that the inspections do not fall in months with peak customer demands. The system-generated schedule is then displayed to a user for approval. The user can then manually adjust this schedule before his/her approval.

The computations for FFH and FFS will vary depending on the manufacturer and model of the power generation equipment being evaluated. Further, the FFH and FFS are part specific, meaning that each individual part or drawing number within the unit/system has it's own calculated FFH and FFS. In evaluating the FFH and FFS, in general, a number of factors are taken into consideration. For example, a typical FFH determination takes into consideration factors such as: the modes of operation, such as the wet and dry modes; the types of fuels, such as gas, distillate and heavy fuels; the types and percentages of the injection modes, such as water or steam; the operating hours using the various fuels; and the operating hours at various load levels, such as at peak load and at a reduced load. Similarly, a typical FFS determination takes into consideration factors such as: the number of start/stop cycles for various starting conditions, such as emergency starts, fast load starts, partial load starts, peak load starts, base load starts; the number and severity of trips; the actual hours of operation, and the hours of operation on various fuels; the number of starts using various fuels, such as gas, distillate fuel and heavy fuel; and the types of injection modes. Thus, these determinations are utilized to provide a cumulative measure of FFH and FFS to determine if a design limit has been exceeded.

### Predicting Costs

As mentioned above, this part of the disclosure comprises predicting the cost and price of a long term service agreement contract. This part takes the detailed schedule generated by the earlier procedure as input and then sequentially simulates the execution of each event in the schedule. For every event in the schedule, it does the following.

1. Determines all the parts that have to be replaced;

2. Checks to see if the spare parts for replacement are available in the inventory pools established to service this contract;

3. Determines any new spare parts that need to be purchased;

4. Schedules the parts that come out of a unit for repair (refurbishment) if required;

5. Determines all the services that need to be performed during the event;

6. Estimates any risks that are associated with the event; and

7. Computes all costs and prices that are associated with the event including those for parts, services, repairs and risks.

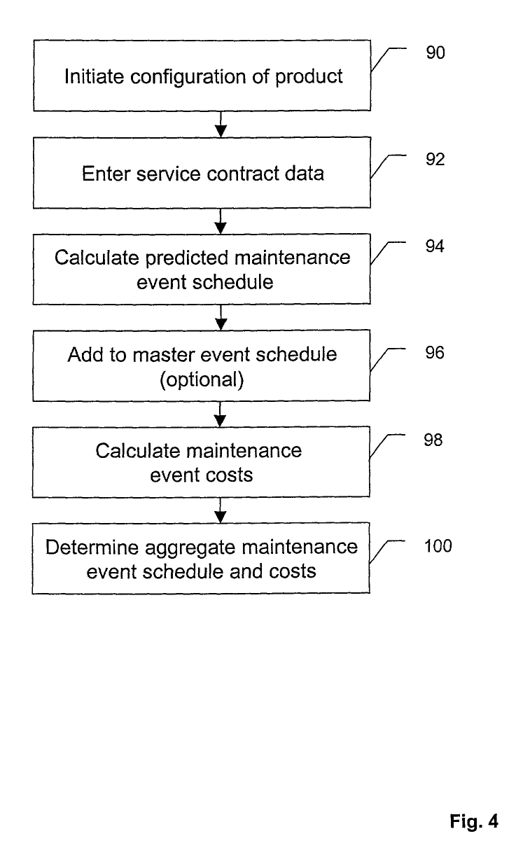

The numbers for all the events are then aggregated to get the costs and prices for the entire long term service agreement. A flowchart explaining the above-described maintenance schedule and costs prediction is set forth in FIGS. 4-7.

Referring to FIG. 4, a user of the computer system 10 (FIG. 1) initiates the maintenance schedule and cost prediction process by entering data through the input/output devices 18 and 20 and viewing the display 22 (Step 90). The data includes the configuration information of the product for which the prediction is being generated. The user then processes a mobilization event, which includes entering data related to the service contract to initiate the scheduling process (Step 92). The system 28 (FIG. 2) then calculates the predicted maintenance event schedule for the product (Step 94), as will be described in more detail below. Once the predicted maintenance event schedule is determined for the product, the predicted schedule may be optionally added to a master event schedule that incorporates the predicted schedules from a plurality of products (Step 96). For example, the master event schedule may be utilized to maintain and analyze the maintenance schedules for a portfolio of products, where the portfolio of products represents a single contract with a single customer or multiple contracts with multiple customers. The system 28 then takes the predicted maintenance event schedule for the product, or the master event schedule for the portfolio of products, and calculates the event costs (Step 98), as will be discussed in more detail below. The system 28 processes this information until the end of the term of the contract is reached, and then determines the aggregated maintenance schedule and costs (Step 100).

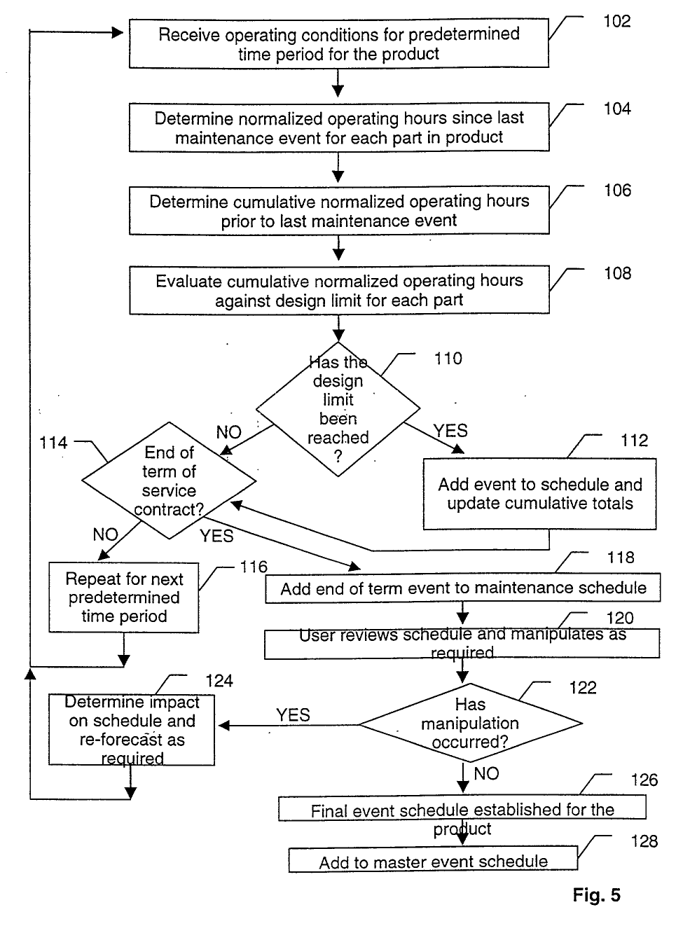

Referring to FIG. 5, in one preferred embodiment of calculating the schedule for power generation equipment, the system 28 reads the operating conditions for a predetermined time period, such as a month, in order to determine the affect of those operating conditions on the life cycle of the parts in the product (Step 102). In this case, the predetermined time period is a portion of the term of the service contract. The predetermined time period may be any time period up to the term of the service contract, but incremental portions of the entire term are preferred for ease of scheduling and processing. Also in this example, the operating conditions include the operating hours of the predetermined time period, the number of times the equipment was started, as well as the operating conditions during the operating hours. The system 28 then obtains the operating hours and starts since the last scheduled maintenance event for each part in the product (Step 104). It should be noted that the last scheduled maintenance event may be different for each part in the product, and this data is stored and recalled from the product data 30 within the mass storage device 26. The system 28 also obtains the cumulative operating hours and starts prior to the last scheduled maintenance event for each part in the product (Step 106) from the product data 30.

Using these numbers, the system 28 can determine a normalized measure of operating hours since the last repair, as well as a normalized cumulative total operating hours (which include operating hours prior to the last repair), for each part. In this case, the operating hours are normalized as factored fired hours (FFH), which are the hours of operation of the equipment under normal operating conditions. Further the equipment starts are normalized as factored fired starts (FFS). The operating hours and starts are normalized because the different conditions experienced by power generation equipment during normal operating conditions and starts each have a different affect on the life cycle of each part in the unit, based on the unique characteristics of each part. The FFH and FFS design limits generally correspond to the expendable life of a part, where each part has a first expendable life under continuous, normal operating conditions and a second expendable life based on the number of starts to which the part is exposed. Thus, each part has an FFH design limit and an FFS design limit. One skilled in the art will realize, however, that many other measures may be utilized to determine when a part needs maintenance and when a part needs to be replaced based on the cumulative operating conditions and repair history of the part.

The system 28 then evaluates the total operating hours since the last scheduled maintenance event, and the cumulative operating hours, against the design limit for each part in the product (Step 108). The system 28 then queries whether the design limit for the part has been reached (Step 110).

Each part has a design limit that includes a repair limit and a replacement limit. The repair limit is the number of operating hours the part may experience before it needs to be taken out of the product and repaired. The replacement limit is the maximum number of operating hours, or the maximum number of times, that a part may experience. For example, a turbine blade may have design limits of 24,000 operating hours, 50 starts and 2 total repairs or refurbishments. As such, the turbine blade may be used for a maximum of 72,000 operating hours or 150 starts, both including 2 repairs. Thus, after experiencing operating conditions that equate to the 24,000 hour or 50 start design limit, a new turbine blade, meaning one that was installed with cumulative operating time and starts of zero, needs to be removed from the product and repaired. Further, after experiencing operating conditions that cumulatively total the equivalent of 72,000 hours or 150 starts, each including 2 repairs, or after experiencing 2 repairs and the equivalent of 24,000 operating hours or 50 starts since the last repair, the turbine blade can no longer be repaired and must be replaced with a new part.

If a design limit has been reached, then the system 28 adds an event to the maintenance schedule for the product and updates the cumulative totals, such as the cumulative operating hours, the cumulative starts and the cumulative number of repairs (Step 112). After updating the schedule in Step 112, or if the design limit was not reached in Step 110, then the system 28 queries whether the end of the term of the contract has been reached (Step 114). If the end of the term has not been reached, then the system returns to Step 102 and repeats the process for the next predetermined time period, or month in this case (Step 116). If the end of the term has been reached, then the system 28 adds an end of term maintenance event to the schedule for the product (Step 118).

The user is then able to review the schedule and make any required changes (Step 120). For example, the user may change the schedule maintenance events to an earlier date to avoid such problems as holidays or manpower or parts shortages. The system 28 then queries whether the maintenance event schedule has been manipulated (Step 122). If the schedule has been adjusted by the user, the system 28 determines the impact upon the schedule and reforecasts the schedule as required (Step 124). For example, if a predicted maintenance event has been moved to an earlier date, then future maintenance events would typically have to be moved to earlier dates in order not to exceed any design limits. If the schedule has not been adjusted, then the system 28 establishes the final maintenance event schedule for the product (Step 126) and optionally adds it to the master event schedule (Step 128).

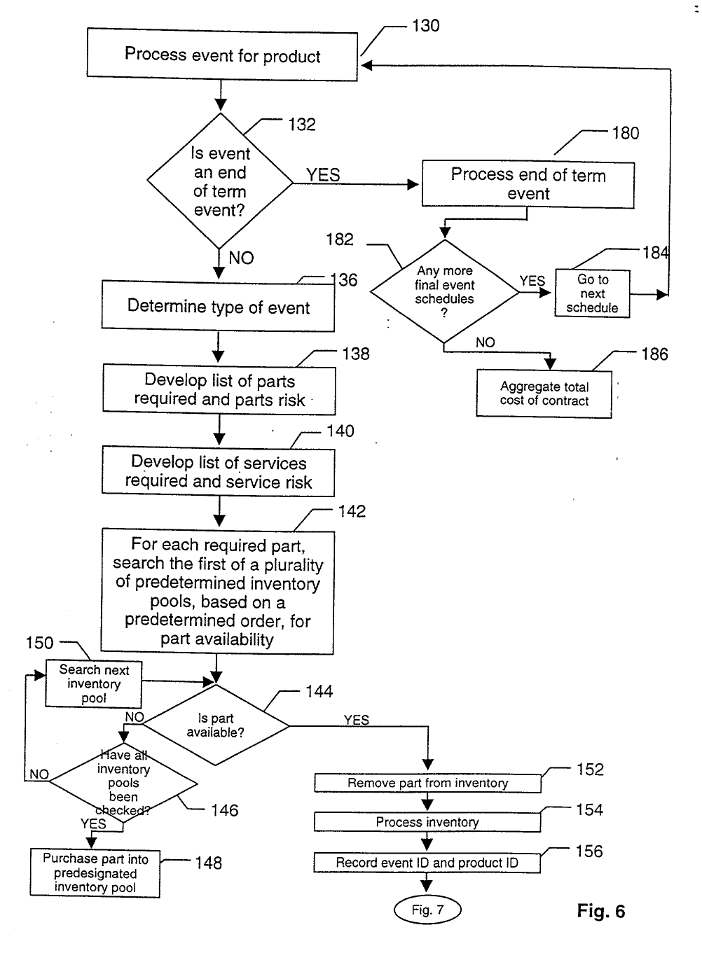

Referring to FIG. 6, in one preferred embodiment of calculating the maintenance event costs for power generation equipment, the system 28 uses the simulator 62 to process the first event on the final maintenance event schedule for the product or portfolio (Step 130). The system 28 then queries whether the event is an end of term event (Step 132). If the event is not an end of term event, then the system 28 determines the type of the event (Step 136), and develops a list of the parts to be replaced (Step 138) and the services to be performed (Step 140), along with the associated parts and service risks, respectively, based on the event type. For example, the simulator 62 may access the service data 58, the risk data 54 and the product data 30 to extract the information relevant to the event type. Using this data the system determines the parts to be replaced and the services to be performed, as well as the associated costs and risks. Using the list of parts to be replaced, the system 28 then goes to one or more predetermined pools of inventory to determine the availability of the part (Step 142).

For example, there may be one or a plurality of customer inventory pools of parts where only the designated customer may have access to the inventory. Also, there may be a service contractor inventory of parts that may be used to service any customer within the service contractor's portfolio of service agreements. Further, the service agreement may designate a predetermined order of searching the one or more inventory pools to get the part.

The system 28 then queries whether the part is available within the designated inventory pool (Step 144). If the part is not in the first predetermined inventory pool, the system then queries whether all inventory pools have been searched (Step 146). If so, the system then processes an order to buy the part into a predesignated inventory pool (Step 148). For example, in the service agreement, the customer may want any purchased parts to be entered into the customer inventory pool so that the customer has exclusive access to these parts. In such a case, for example, the cost of replacing the part will be higher because access to the inventory of parts is restricted to the one customer as opposed to being shared by many customers.

If all of the inventory pools have not been checked (Step 146), then the system searches for the part in the next inventory pool based on the predetermined order until the part is located or until all inventory pools have been searched (Step 150). Once the part is found or purchased, the part is removed from the inventory (Step 152) and the inventory is processed to determine the parts costs and risks associated with the event (Step 154). Further, the event identification and the product identification are recorded in an inventory register so that a history of the inventory transaction is maintained (Step 156).

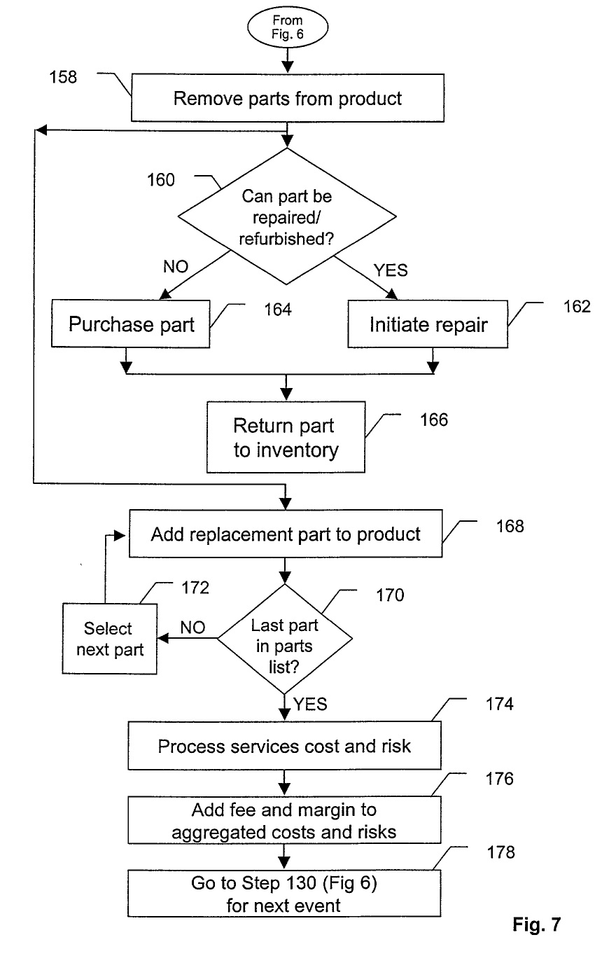

Referring to FIG. 7, once all parts are withdrawn from inventory, the simulator 62 further processes the maintenance event by simulating the removal of the parts from the product (Step 158). The system then queries whether each of the parts can be repaired or refurbished (Step 160). Each part has a design limit for the number of times that the part can be repaired or refurbished. This repair design limit is stored as part of the product data 30 within the database 26. If repair is possible, then the system schedules the appropriate transaction to have the part repaired (Step 162). If repair is not possible, then the system simulates the purchase of a new part (Step 164). Then, the new or repaired part is returned to the inventory from which the replacement part was removed (Step 166). The system then simulates adding each replacement part to the product (Step 168) and queries whether this is the last part in the part list (Step 170). If more parts are on the list, then the system selects the next part in the list and repeats the process (Step 172). If there are no more parts in the list, then the system processes the services to determine the service cost and risk (Step 174). Optionally, a fee and a margin may be added to the parts and service costs and risks for the event (Step 176). At step 178, the system then returns to step 130 (FIG. 6) to process the next event in the final maintenance schedule for the product.

Returning to FIG. 6, if the system determines that the next event is an end of term event (Step 132), then the system processes the end of term event (Step 180). For example, the end of term event signals the end of the maintenance contract. At the end of the maintenance contract certain contract conditions may need to be satisfied, such as a required number of parts in inventory, a minimum remaining operating life on the parts within the unit, etc. These conditions may be analyzed and processed by the present system. After processing the end of term event for the product, the system queries whether or not there are any more final event schedules to be evaluated (Step 182). For example, additional final event schedules may be analyzed when estimating the costs of a service contract that includes a portfolio of products. If there are other final event schedules, then the system gets the next event schedule (Step 184) and begins processing (Step 130). If no more final event schedules are to be analyzed, then the system 28 aggregates the total cost of the service contract (Step 186). For ease of analysis, this aggregated cost includes total costs and a breakdown of the various parts and service costs and risks, as well as fees and margins, for each event in the maintenance schedule.

The foregoing schematic drawings and flow charts show the architecture, functionality, and operation of a possible implementation of the system for predicting a maintenance schedule and costs for performing future service events of a product. In this regard, each block represents a module, segment, or portion of code, which comprises one or more executable instructions for implementing the specified logical function(s). It should also be noted that in some alternative implementations, the functions noted in the blocks may occur out of the order noted in the figures, or for example, may in fact be executed substantially concurrently or in the reverse order, depending upon the functionality involved.

The above-described system and method for predicting a maintenance schedule and costs for performing future service events of a product comprise an ordered listing of executable instructions for implementing logical functions. The ordered listing can be embodied in any computer-readable medium for use by or in connection with a computer-based system that can retrieve the instructions and execute them. In the context of this application, the computer-readable medium can be any means that can contain, store, communicate, propagate, transmit or transport the instructions. The computer readable medium can be, for example but not limited to, an electronic, magnetic, optical, electromagnetic, infrared, or semiconductor system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). It is even possible to use paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

It is apparent that there has been provided in accordance with this invention, a system and method for predicting a maintenance schedule and costs for performing future service events of a product. While the invention has been particularly shown and described in conjunction with a preferred embodiment thereof, it will be appreciated that variations and modifications can be effected by a person of ordinary skill in the art without departing from the scope of the invention.

What is claimed is:

1. A system for predicting a maintenance schedule and costs of future service events of a product, comprising:
a scheduler that determines a list of future service events for the product;
a simulator that simulates each of the listed future service events for the product to determine a cost; and
an aggregator that accumulates the list of future service events and the associated cost to formulate the predicted future maintenance schedule and costs.

2. The system according to claim 1, wherein the scheduler sequences the timing of the future service events according to occurrence.

3. The system according to claim 1, further comprising a scheduler adjuster that adjusts the schedule of the listed service events.

4. The system according to claim 1, wherein the simulator determines parts that have to be replaced for each future service event.

5. The system according to claim 1, wherein the simulator determines the availability of any spare parts needed for the future service events.

6. The system according to claim 1, wherein the simulator schedules the replacement of required parts for the future service events.

7. The system according to claim 1, wherein the simulator estimates the risks associated with each of the future service events.

8. The system according to claim 1, wherein the aggregator further comprises a cost aggregator that aggregates the total cost associated with the future service events.

9. A system for predicting a maintenance schedule and costs of future service events of a product serviced under a service agreement having a term, comprising:
a scheduler that determines a list of future service events for a predetermined time period based on operating conditions and design limit data, the operating conditions corresponding to the predetermined time period, the design limit data corresponding to each part in the product;
a simulator that determines the cost associated with each of the future service events; and
an aggregator that aggregates the future service events and the costs, the future service events aggregated into the maintenance schedule and the costs of the future service events aggregated into a total cost representative of fulfilling the service agreement.

10. The system of claim 9, further comprising:
the design limit data including an operating time design limit for each part of the product; and
wherein the scheduler:
calculates an operating time for each part in the product for the predetermined time period based on the corresponding operating conditions;
determines whether the calculated operating time exceeds the operating time design limit for each part of the product; and
schedules a maintenance event if the calculated operating time exceeds the operating time design limit for any part in the product.

11. The system of claim 10, wherein the scheduler further:
adds the calculated operating time for each part of the product to a cumulative calculated operating time for each part of the product, the cumulative calculated operating time for each part corresponding to a sum of the calculated operating times since a last scheduled maintenance event for the part;
determines whether the cumulative calculated operating time exceeds the operating time design limit for each part of the product; and
schedules a maintenance event if the cumulative calculated operating time exceeds the operating time design limit for any part of the product.

12. The system of claim 10, further comprising:
the predetermined time period comprising the term of the service agreement;
the operating conditions including a plurality of sets of operating conditions corresponding to a plurality of sets of time periods within the predetermined time period; and
wherein the scheduler:
determines the calculated operating time and the cumulative calculated operating time limit for each part of the product for each of the plurality of sets of operating conditions; and
schedules a maintenance event if the calculated operating time or the cumulative calculated operating time exceeds the operating time design limit for any part of the product.

13. The system of claim 9, wherein the scheduler further determines a parts cost associated with each scheduled service event.

14. The system of claim 9, wherein the scheduler further determines a parts risk associated with each scheduled service event.

15. The system of claim 9, wherein the scheduler further determines a service cost associated with each scheduled service event.

16. The system of claim 9, wherein the scheduler further determines a service risk associated with each scheduled service event.

17. The system of claim 9, wherein the simulator further:
determines a list of parts to be replaced for each of the future service events;
determines a list of services to be performed for each of the future service events;
determines a part cost for each of the parts to be replaced for each of the future service events; and
determines a service cost for each of the of services to be performed for each of the future service events.

18. The system of claim 9, wherein the simulator further:
retrieves a previously-stored part cost associated with each of the parts to be replaced; and
retrieves a previously-stored service cost associated with each of the services to be performed.

19. The system of claim 9, wherein the simulator further:
determines a list of parts to be replaced for each of the future service events;
determines a list of services to be performed for each of the future service events;
determines a part risk for each of the parts to be replaced for each of the future service events; and
determines a service risk for each of the of services to be performed for each of the future service events.

20. The system of claim 19, wherein the simulator further:
retrieves a previously-stored part risk associated with each of the parts to be replaced; and
retrieves a previously-stored service risk associated with each of the services to be performed.

21. The system of claim 9, wherein the simulator further:
determines a list of parts to be replaced for each of the future service events;
determines a list of services to be performed for each of the future service events;
determines a part cost and a part risk for each of the parts to be replaced for each of the future service events; and
determines a service cost and a service risk for each of the of services to be performed for each of the future service events.

22. The system of claim 21, wherein the simulator further:
retrieves a previously-stored part cost and part risk, respectively, associated with each of the parts to be replaced; and
retrieves a previously-stored service cost and service risk, respectively, associated with each of the services to be performed.

23. The system of claim 9, wherein the simulator further:
determines a list of parts to be replaced for each of the future service events;
determines the availability of each of the parts to be replaced.

24. The system of claim 23, wherein the simulator further searches a predetermined inventory pool.

25. The system of claim 24, wherein the predetermined inventory pool comprises one of a private inventory pool associated exclusively with the service agreement, a common inventory pool associated with a plurality of service agreements, a refurbished parts inventory pool, and a new parts inventory pool.

26. The system of claim 23, wherein the simulator further searches a plurality of inventory pools in a predetermined order.

27. The system of claim 23, wherein the simulator further determines if a new part can be purchased.

28. The system of claim 9, wherein the simulator further determines a fee for each of the future service events.

29. A method for predicting a maintenance schedule and costs of future service events of a product, comprising:
determining a list of future service events for the product;
simulating each of the listed future service events for the product; and
aggregating the maintenance schedule and costs associated with the events.

30. The method according to claim 29, wherein the simulating comprises sequencing the timing of the future service events according to occurrence.

31. The method according to claim 29, further comprising adjusting the schedule of the listed service events.

32. The method according to claim 29, wherein the simulating comprises determining parts that have to be replaced for each future service event.

33. The method according to claim 29, wherein the simulating comprises determining the availability of any spare parts needed for the future service events.

34. The method according to claim 29, wherein the simulating comprises scheduling the replacement of required parts for the future service events.

35. The method according to claim 29, wherein the simulating comprises estimating the risks associated with each of the future service events.

36. The method according to claim 29, where aggregating further comprises aggregating the total cost associated with the future service events.

37. A method for predicting a maintenance schedule and costs of future service events of a product serviced under a service agreement having a term, comprising:
determining a list of future service events for a predetermined time period based on operating conditions and design limit data, the operating conditions corresponding to the predetermined time period, the design limit data corresponding to each part in the product;
determining the cost associated with each of the future service events; and
aggregating the maintenance schedule and cost of the future service events, the maintenance schedule comprising the aggregated list of future events and the costs aggregated into a total cost representative of fulfilling the service agreement.

38. The method of claim 37, where determining the list of future service events further comprises:
the design limit data including an operating time design limit for each part of the product;
calculating an operating time for each part in the product for the predetermined time period based on the corresponding operating conditions;
determining whether the calculated operating time exceeds the operating time design limit for each part of the product; and
scheduling a maintenance event if the calculated operating time exceeds the operating time design limit for any part in the product.

39. The method of claim 38, where determining the list of future service events further comprises:
adding the calculated operating time for each part of the product to a cumulative calculated operating time for each part of the product, the cumulative calculated operating time for each part corresponding to a sum of the calculated operating times since a last scheduled maintenance event for the part;
determining whether the cumulative calculated operating time exceeds the operating time design limit for each part of the product; and
scheduling a maintenance event if the cumulative calculated operating time exceeds the operating time design limit for any part of the product.

40. The method of claim 38, where determining the list of future service events further comprises:
the predetermined time period comprising the term of the service agreement;
the operating conditions including a plurality of sets of operating conditions corresponding to a plurality of sets of time periods within the predetermined time period;
determining the calculated operating time and the cumulative calculated operating time limit for each part of the product for each of the plurality of sets of operating conditions; and
scheduling a maintenance event if the calculated operating time or the cumulative calculated operating time exceeds the operating time design limit for any part of the product.

41. The method of claim 37, where determining the cost associated with each of the future service events further comprises determining a parts cost associated with each scheduled service event.

42. The method of claim 37, where determining the cost associated with each of the future service events further comprises determining a parts risk associated with each scheduled service event.

43. The method of claim 37, where determining the cost associated with each of the future service events further comprises determining a service cost associated with each scheduled service event.

44. The method of claim 37, where determining the cost associated with each of the future service events further comprises determining a service risk associated with each scheduled service event.

45. The method of claim 37, where determining the cost associated with each of the future service events further comprises simulating each of the future service events for the product.

46. The method of claim 45, where simulating each of the future service events for the product further comprises:
determining a list of parts to be replaced for each of the future service events;
determining a list of services to be performed for each of the future service events;
determining a part cost for each of the parts to be replaced for each of the future service events; and
determining a service cost for each of the of services to be performed for each of the future service events.

47. The method of claim 46, where determining the part cost and the service cost, respectively, further comprises:
retrieving a previously-stored part cost associated with each of the parts to be replaced; and
retrieving a previously-stored service cost associated with each of the services to be performed.

48. The method of claim 45, where simulating each of the future service events for the product further comprises:
determining a list of parts to be replaced for each of the future service events;
determining a list of services to be performed for each of the future service events;
determining a part risk for each of the parts to be replaced for each of the future service events; and
determining a service risk for each of the of services to be performed for each of the future service events.

49. The method of claim 48, where determining the part risk and the service risk, respectively, further comprises:
retrieving a previously-stored part risk associated with each of the parts to be replaced; and
retrieving a previously-stored service risk associated with each of the services to be performed.

50. The method of claim 45, where simulating each of the future service events for the product further comprises:
determining a list of parts to be replaced for each of the future service events;
determining a list of services to be performed for each of the future service events;
determining a part cost and a part risk for each of the parts to be replaced for each of the future service events; and
determining a service cost and a service risk for each of the of services to be performed for each of the future service events.

51. The method of claim 50, where determining the part cost, the part risk, the service cost, the service risk, respectively, further comprises:
retrieving a previously-stored part cost and part risk, respectively, associated with each of the parts to be replaced; and
retrieving a previously-stored service cost and service risk, respectively, associated with each of the services to be performed.

52. The method of claim 45, where simulating each of the future service events for the product further comprises:
determining a list of parts to be replaced for each of the future service events;
determining the availability of each of the parts to be replaced.

53. The method of claim 52, where determining the availability of each of the parts to be replaced further comprises searching a predetermined inventory pool.

54. The method of claim 53, where the predetermined inventory pool comprises one of a private inventory pool associated exclusively with the service agreement, a common inventory pool associated with a plurality of service agreements, a refurbished parts inventory pool, and a new parts inventory pool.

55. The method of claim 52, where determining the availability of each of the parts to be replaced further comprises searching a plurality of inventory pools in a predetermined order.

56. The method of claim 52, where determining the availability of each of the parts to be replaced further comprises determining if a new part can be purchased.

57. The method of claim 37, where determining the cost associated with each of the future service events further comprises determining a fee for each of the future service events.

58. A computer-readable medium storing computer instructions for instructing a computer system to predict a maintenance schedule and costs of future service events of a product, the computer instructions comprising:
determining a list of future service events for the product;
simulating each of the listed future service events for the product; and
aggregating the costs associated with the events.

59. The computer-readable medium according to claim 58, wherein the simulating instructions comprise sequencing the timing of the future service events according to occurrence.

60. The computer-readable medium according to claim 58, further comprising instructions for adjusting the schedule of the listed service events.

61. The computer-readable medium according to claim 58, wherein the simulating instructions comprise determining parts that have to be replaced for each future service event.

62. The computer-readable medium according to claim 58, wherein the simulating instructions comprise determining the availability of any spare parts needed for the future service events.

63. The computer-readable medium according to claim 58, wherein the simulating instructions comprise scheduling the replacement of required parts for the future service events.

64. The computer-readable medium according to claim 58, wherein the simulating instructions comprise estimating the risks associated with each of the future service events.

65. The computer-readable medium according to claim 58, where the aggregating instructions further comprise instructions for aggregating the total cost associated with the future service events.

66. A computer-readable medium storing computer instructions for instructing a computer system to predict a maintenance schedule and costs of future service events of a product, the computer instructions comprising:
determining a list of future service events for a predetermined time period based on operating conditions and design limit data, the operating conditions corresponding to the predetermined time period, the design limit data corresponding to each part in the product;
determining the cost associated with each of the future service events; and
aggregating the cost of the future service events into a total cost representative of fulfilling the service agreement.

67. The method of claim 66, where the instructions determining the list of future service events further comprise:
the design limit data including an operating time design limit for each part of the product;
calculating an operating time for each part in the product for the predetermined time period based on the corresponding operating conditions;
determining whether the calculated operating time exceeds the operating time design limit for each part of the product; and
scheduling a maintenance event if the calculated operating time exceeds the operating time design limit for any part in the product.

68. The computer-readable medium of claim 67, where the instructions for determining the list of future service events further comprise:
adding the calculated operating time for each part of the product to a cumulative calculated operating time for each part of the product, the cumulative calculated operating time for each part corresponding to a sum of the calculated operating times since a last scheduled maintenance event for the part;
determining whether the cumulative calculated operating time exceeds the operating time design limit for each part of the product; and
scheduling a maintenance event if the cumulative calculated operating time exceeds the operating time design limit for any part of the product.

69. The computer-readable medium of claim 67, where the instructions for determining the list of future service events further comprise:
the predetermined time period comprising the term of the service agreement;
the operating conditions including a plurality of sets of operating conditions corresponding to a plurality of sets of time periods within the predetermined time period;
determining the calculated operating time and the cumulative calculated operating time limit for each part of the product for each of the plurality of sets of operating conditions; and
scheduling a maintenance event if the calculated operating time or the cumulative calculated operating time exceeds the operating time design limit for any part of the product.

70. The computer-readable medium of claim 66, where the instructions for determining the cost associated with each of the future service events further comprise determining a parts cost associated with each scheduled service event.

71. The computer-readable medium of claim 66, where the instructions for determining the cost associated with each of the future service events further comprises determining a parts risk associated with each scheduled service event.

72. The computer-readable medium of claim 66, where the instructions for determining the cost associated with each of the future service events further comprise determining a service cost associated with each scheduled service event.

73. The computer-readable medium of claim 66, where the instructions for determining the cost associated with each of the future service events further comprise determining a service risk associated with each scheduled service event.

74. The computer-readable medium of claim 66, where the instructions for determining the cost associated with each of the future service events further comprise simulating each of the future service events for the product.

75. The computer-readable medium of claim 74, where the simulating further comprise:
determining a list of parts to be replaced for each of the future service events;
determining a list of services to be performed for each of the future service events;
determining a part cost for each of the parts to be replaced for each of the future service events; and
determining a service cost for each of the of services to be performed for each of the future service events.

76. The computer-readable medium of claim 75, where the instructions for determining the part cost and the service cost, respectively, further comprise:
retrieving a previously-stored part cost associated with each of the parts to be replaced; and
retrieving a previously-stored service cost associated with each of the services to be performed.

77. The computer-readable medium of claim 74, where the instructions further comprise:
determining a list of parts to be replaced for each of the future service events;
determining a list of services to be performed for each of the future service events;
determining a part risk for each of the parts to be replaced for each of the future service events; and
determining a service risk for each of the of services to be performed for each of the future service events.

78. The computer-readable medium of claim 77, where the instructions for determining the part risk and the service risk, respectively, further comprise:
retrieving a previously-stored part risk associated with each of the parts to be replaced; and
retrieving a previously-stored service risk associated with each of the services to be performed.

79. The computer-readable medium of claim 74, where simulating instructions further comprise:
determining a list of parts to be replaced for each of the future service events;
determining a list of services to be performed for each of the future service events;
determining a part cost and a part risk for each of the parts to be replaced for each of the future service events; and
determining a service cost and a service risk for each of the of services to be performed for each of the future service events.

80. The computer-readable medium of claim 79, where the instructions for determining the part cost, the part risk, the service cost, the service risk, respectively, further comprise:
retrieving a previously-stored part cost and part risk, respectively, associated with each of the parts to be replaced; and
retrieving a previously-stored service cost and service risk, respectively, associated with each of the services to be performed.

81. The computer-readable medium of claim 74, where the simulating instructions further comprise:
determining a list of parts to be replaced for each of the future service events;
determining the availability of each of the parts to be replaced.

82. The computer-readable medium of claim 81, where the instructions for determining the availability of each of the parts to be replaced further comprise searching a predetermined inventory pool.

83. The computer-readable medium of claim 82, where the predetermined inventory pool comprises one of a private inventory pool associated exclusively with the service agreement, a common inventory pool associated with a plurality of service agreements, a refurbished parts inventory pool, and a new parts inventory pool.

84. The computer-readable medium of claim 82, where the instructions for determining the availability of each of the parts to be replaced further comprise searching a plurality of inventory pools in a predetermined order.

85. The computer-readable medium of claim 82, where the instructions for determining the availability of each of the parts to be replaced further comprise determining if a new part can be purchased.

86. The computer-readable medium of claim 66, where the instructions for determining the cost associated with each of the future service events further comprise determining a fee for each of the future service events.
